(19) United States
(12) Patent Application Publication
(10) Pub. No.: US 2001/0024339 A1
(43) Pub. Date: Sep. 27, 2001

(54) Head actuator control system for disk drive

(76) Inventor: Koji Yaegashi, Ome-shi (JP)

Correspondence Address: PILLSBURY WINTHROP LLP, 1600 TYSONS BOULEVARD, MCLEAN, VA, 22102, US

(21) Appl. No.: 09/768,786

(22) Filed: Jan. 25, 2001

(30) Foreign Application Priority Data
Jan. 25, 2000 (JP) 2000-016192

(51) Int. Cl. G11B 21/02

(52) U.S. Cl. 360/75

(57) ABSTRACT

This invention discloses a disk drive having a loading/unloading mechanism. In the loading/unloading mechanism, an actuator is latched by a latch mechanism while a head is retracted to a ramp member. At the start of loading operation, the CPU of the drive supplies a driving current at a boosted voltage higher in level than a main power supply voltage, and drives a VCM to release latch of the actuator. Power by the boosted voltage is supplied to the VCM using an auxiliary power supply used in retract operation.

### CROSS-REFERENCE TO RELATED APPLICATIONS

This application is based upon and claims the benefit of priority from the prior Japanese Patent Application No. 2000-016192, filed Jan. 25, 2000, the entire contents of which are incorporated herein by reference.

### BACKGROUND OF THE INVENTION

The present invention relates to a disk drive having a loading/unloading mechanism and, more particularly, to a head actuator control system applied to this drive.

In recent years, especially small-size hard disk drives are used not only as the storage memory of a personal computer but also as the storages of various digital devices such as a digital television apparatus or mobile information device.

Unlike stay-at-home type devices such as a desktop computer, small-size digital devices such as a notebook personal computer and mobile information device are portable, and are used in an environment where they are readily susceptible to external vibrations or shocks. The main power supply of such a small-size digital device uses a charging battery in addition to an AC power supply, and is designed in accordance with low-power-consumption specifications. In a small-size disk drive used in a small-size digital device, measures against external vibrations or shocks, and reduction in power consumption are important design factors.

To resist vibrations or shocks, the small-size disk drive adopts a loading/unloading mechanism and a magnetic latch type latch mechanism (or carriage lock mechanism). To reduce power consumption, the disk drive uses a low-voltage-level power supply (e.g., 3.3-V power supply).

The loading/unloading mechanism unloads; it moves a head to a retract position defined by a ramp member disposed outside a disk in non-operation such as a power OFF state. Unloading operation is called retract operation particularly in the power OFF state. Further, the loading/unloading mechanism loads; it moves the head retracted at the retract position onto the disk at the start of read/write operation.

The loading/unloading mechanism is constituted by an actuator which supports the head, a microprocessor (CPU) serving as the main controller of the drive, and a VCM (Voice Coil Motor) driver. The actuator is rotated radially along the disk by the driving force of the VCM, and moves the head within the range between the inner and outer peripheries of the disk and the range from the disk to the retract position. The head is a slider having read and write head elements.

The magnetic latch type latch mechanism uses the magnetic force of a magnet included in the VCM, attracts a latch plate attached to a VCM coil (serving as the driving unit of the actuator), and latches (locks) the actuator while the head is retracted at the retract position. This mechanism maintains the actuator in a halt state (latched or locked state) even if slight vibrations or shocks act on the drive. The head mounted on the actuator is held at the retract position (ramp member) to avoid collision against the disk.

In short, in the small-size disk drive particularly used in a small-size portable digital device, reduction in power consumption, the loading/unloading mechanism, and the magnetic latch type latch mechanism are important design factors in practical use.

However, implementation of these design factors suffers the following problem. That is, the magnetic latch type latch mechanism desirably exhibits a sufficient latch force against vibrations or shocks so as not to move the head from the retract position in latching (locking) the actuator (in practice, the VCM coil). On the other hand, the voltage level of the power supply voltage of the drive is set low in order to reduce power consumption, so the driving force of the VCM is relatively small. If the latch force of the latch mechanism (magnetic force of the magnet) is excessively increased, latch of the actuator may not be released within a short time at the start of loading operation. At the start of loading operation, the VCM must be activated to rotate the actuator radially along the disk. At this time, if the driving force of the VCM is insufficient, the magnetic latch cannot be immediately released, and a long time is required to move the actuator to the disk. To increase the driving force of the VCM, the power supply voltage must be increased to supply a satisfactory driving current, which inhibits reduction in power consumption.

### BRIEF SUMMARY OF THE INVENTION

It is an object of the present invention to provide a head actuator control system capable of sufficiently increasing the latch force of a latch mechanism in a disk drive without inhibiting reduction in power consumption, and obtaining a VCM driving force enough to release latch at the start of loading operation.

The present invention provides a head actuator control system comprising an actuator mechanism which supports a head, and executes loading operation of moving the head onto a disk by a VCM and unloading operation of moving the head from the disk to a retract position, latch means for latching the actuator mechanism at a predetermined position when the head is moved to the retract position by the unloading operation, first control means for controlling a driving current supplied to the VCM, and executing normal control of the actuator mechanism in order to execute movement and positional control of the head on the disk, and second control means for controlling the driving current supplied to the VCM so as to release latch of the actuator mechanism by the latch means at start of the loading operation of moving the head from the retract position onto the disk.

With this arrangement, the VCM is driven at a voltage higher in level than the voltage of the main power supply of the drive at the start of loading operation. Compared to normal control, a larger VCM driving force can be obtained. Since latch release is facilitated in comparison with a case wherein a smaller VCM driving force at a low voltage level of the main power supply is used, the latch force of the latch mechanism can be relatively increased. Accordingly, a latch mechanism having a latch force enough to resist vibrations or shocks can be realized. In normal control, the VCM is driven at a low voltage level, so that power consumption can be reduced. By applying the present invention, a disk drive which is resistant to vibrations or shocks and is reduced in power consumption can be put into practical use. This disk drive is useful particularly for a small-size portable digital device.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing the main part of a VCM driver according to an embodiment of the present invention;

FIG. 2 is a block diagram showing the main part of the VCM driver according to the embodiment;

FIG. 3 is a view showing the main part of a disk drive according to the embodiment; and

FIG. 4 is a flow chart for explaining actuator control operation according to the embodiment.

### DETAILED DESCRIPTION OF THE INVENTION

An embodiment of the present invention will be described below with reference to the several views of the accompanying drawing.

(Arrangement of Disk Drive)

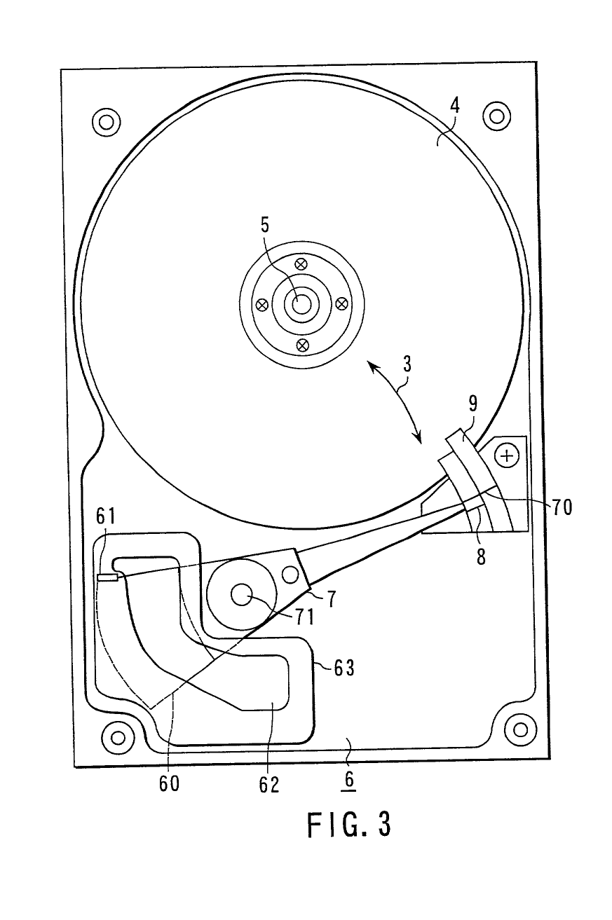

As shown in FIG. 3, a disk drive according to this embodiment is assumed to be a small-size hard disk drive. The disk drive is mainly divided into a drive mechanism called a head disk assembly, and a control system including a microprocessor (CPU) and VCM driver.

The drive mechanism comprises a disk 4 serving as a data recording medium, a spindle motor (SPM) 5 for rotating the disk 4, a voice coil motor (VCM) 6 constituting an actuator mechanism, an actuator 7, and a head 8.

The head 8 is formed from a slider having a read head element (MR head) and a write head element (inductive magnetic head). The head 8 is mounted on the distal end of the actuator 7 via a suspension. The actuator 7 is rotated about a shaft 71 by the driving force of the VCM 6. By driving the actuator 7, the head 8 can be moved in the radial direction (indicated by an arrow 3) of the disk 4.

The VCM 6, the actuator 7, and a ramp member 9 are building elements included in a loading/unloading mechanism. The ramp member 9 is disposed outside the disk 4, and serves as the retract location (or parking area) of the head 8. The ramp member 9 has an inclined portion for holding a tab 70 attached to the distal end of the actuator 7. When the actuator 7 moves to the outside of the disk 4 by unloading operation (or retract operation), the tab 70 is held by the ramp member 9. As a result, the head 8 retracts outside the disk 4. In loading operation, the actuator 7 rotates toward the inner periphery of the disk 4 to move the tab 70 apart from the ramp member 9. Then, the head 8 is moved and loaded onto the disk 4.

The VCM 6 has a VCM coil (driving unit) 60 connected to the actuator 7, a latch plate 61, a magnet 62, and a top yoke 63. In this embodiment, the VCM 6 includes a latch mechanism of latching (locking) the actuator 7 at the retract position (ramp member 9) of the head 8 using the magnetic force of the magnet 62. In practice, the latch mechanism attracts the latch plate 61 attached to the end portion of the VCM coil 60 by the magnetic force of the magnet 62, thereby latching the VCM coil 60. The latch mechanism keeps retracting the head 8 at the retract position (ramp member 9) even if slight vibrations or shocks act on the drive.

(VCM Driver)

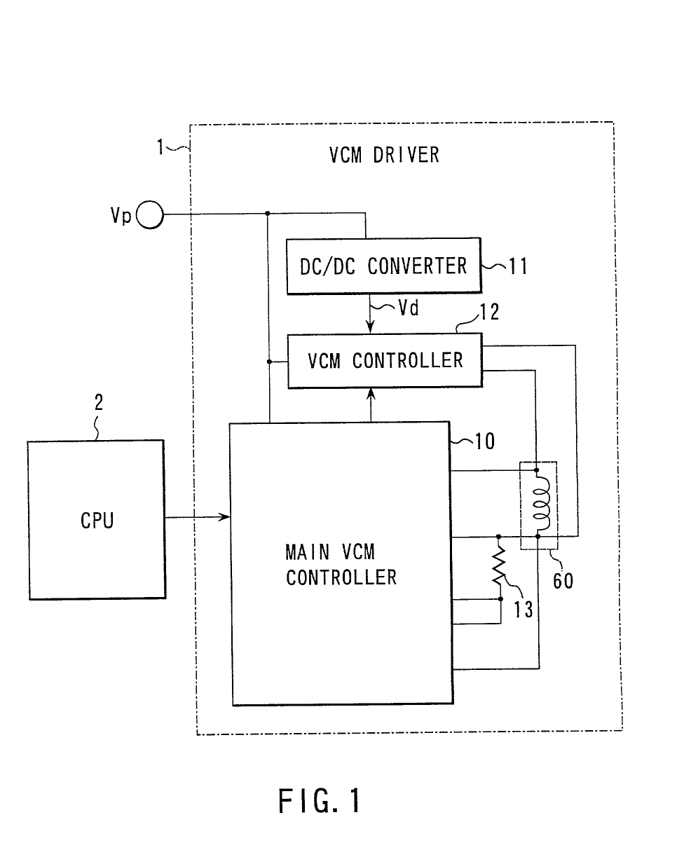

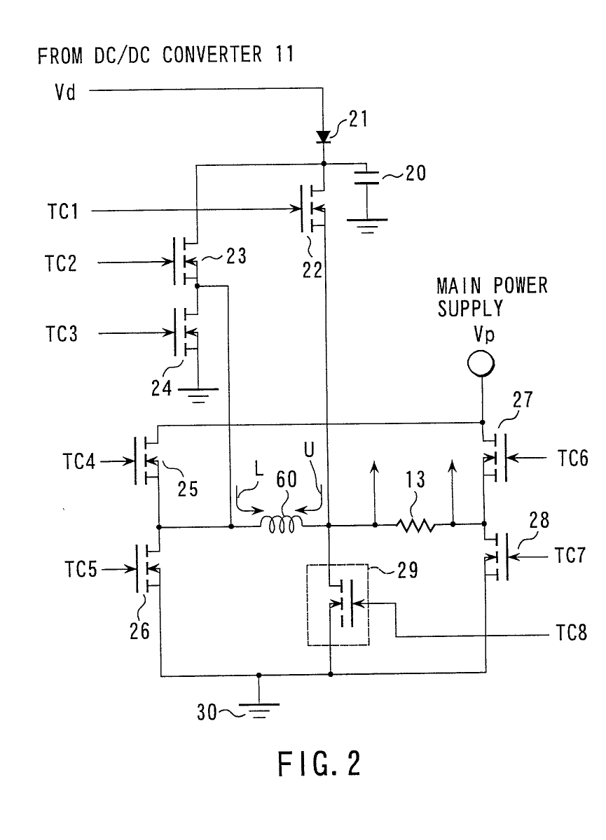

FIGS. 1 and 2 are diagrams showing a VCM driver 1 used in the disk drive of the embodiment.

As shown in FIG. 1, the VCM driver 1 is a motor controller for controlling supply of a driving current to the VCM coil 60 of the VCM 6 under the control of a CPU 2. In a normal disk drive, the VCM driver 1 is assembled as a motor driver IC in an integrated circuit together with a SPM driver serving as the controller of the SPM 5.

The CPU 2 is a main control device for the disk drive that is also called a microcontroller. The CPU 2 performs not only control of the actuator mechanism according to the embodiment, but also rotation control of the disk 4 and control of read/write operation. The CPU 2 controls the VCM driver 1 to drive the actuator mechanism, and loads the head 8 onto the disk 4 and unloads the head 8 from the disk 4 to the ramp member 9.

In turning off the power supply of the drive, a dedicated retract circuit (not shown) functions to retract (unload) the head 8 from the disk 4 to the ramp member 9. That is, in turning the power supply off, the dedicated retract circuit controls the VCM driver 1 to drive the actuator mechanism, instead of the CPU 2.

As shown in FIG. 1, the VCM driver 1 has a main VCM controller 10, DC/DC converter 11, VCM controller 12, and current detection resistor 13. The DC/DC converter 11 functions as a boosting circuit for generating a voltage (to be referred to as a boosted voltage Vd hereinafter) higher in level than a power supply voltage vp of the main power supply of the drive.

The VCM controller 12 uses the boosted voltage Vd supplied from the DC/DC converter 11 to supply a driving current to the VCM coil 60 of the VCM 6 at the start of loading operation according to the embodiment and in retract operation (unloading operation). The current detection resistor 13 is a member for monitoring a current value flowing through the VCM coil 60 by a voltage value. The main VCM controller 10 controls the driving current value of the VCM 6 designated by the CPU 2 on the basis of the monitoring voltage value of the current detection resistor 13.

FIG. 2 is a circuit diagram showing the main parts of the main VCM controller 10 and VCM controller 12. Note that a control circuit for controlling transistors 22 to 29 is not illustrated.

The VCM controller 12 is mainly comprised of a capacitor 20 functioning as an auxiliary power supply, a diode 21, and the transistors 22, 23, and 24. The capacitor 20 is an auxiliary power supply always charged by the boosted voltage Vd supplied from the DC/DC converter 11. The diode 21 is an element for preventing backflow of a current in turning the main power supply off.

The main VCM controller 10 is mainly made up of the transistors 25, 26, 27, and 28, and controls to flow a driving current corresponding to the main power supply voltage Vp to the VCM coil 60. Note that the transistor 29 is an element according to a modification (to be described later). This embodiment employs a line connected to ground 30 in place of the transistor 29.

(Control Operation of Actuator Mechanism)

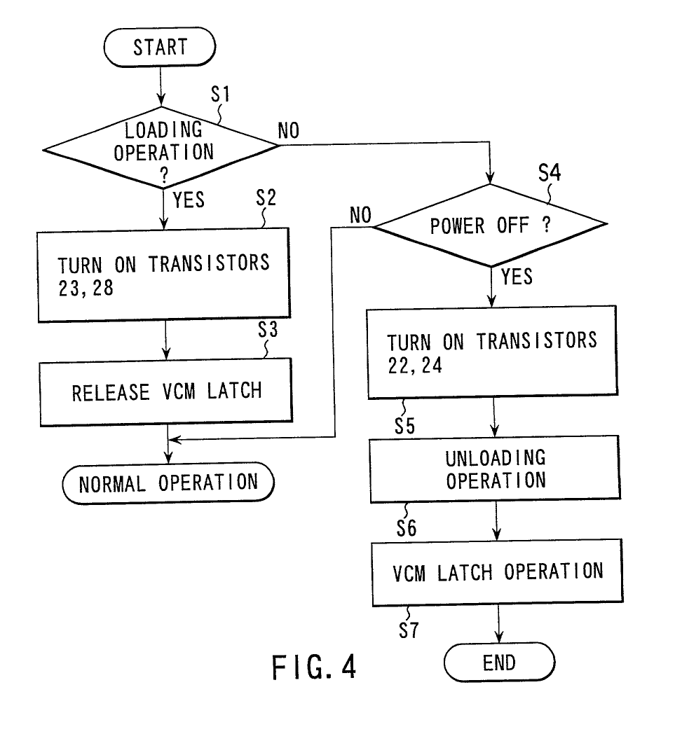

Control operation (loading/unloading operation) of the actuator mechanism according to the embodiment will be explained with reference to the flow chart of FIG. 4 in addition to FIGS. 1, 2, and 3.

If main power (voltage Vp) is applied to the drive, the CPU 2 starts executing predetermined normal control. Normal control includes positioning control (seek control and tracking control) of the head 8 by the CPU 2. At this time, the VCM controller 12 is controlled in accordance with control signals (TC1 and TC3) so as to turn the transistors 22 and 24 off, and is in a function OFF state. Hence, no voltage is supplied to the VCM 6 from the capacitor 20 serving as an auxiliary power supply.

The main VCM controller 10 turns on the transistors 25 and 28 in accordance with control signals (TC4 and TC7) under the control of the CPU 2, and flows a driving current in a direction (L) to the VCM coil 60. Then, the actuator 7 is rotated by the driving force of the VCM 6 from the outer to the inner periphery of the disk 4. The main VcM controller 10 turns on the transistors 26 and 27 in accordance with control signals (TC5 and TC6) under the control of the CPU 2, and flows a driving current in a direction (U) to the VCM coil 60. Then, the actuator 7 is rotated by the driving force of the VCM 6 from the inner to the outer periphery of the disk 4. Under normal control of the CPU 2, the actuator 7 is driven and controlled to position the head 8 to a target position on the disk 4 for the purpose of read/write operation.

If supply of the main power to the disk drive is stopped, the level of the main power supply voltage vp drops to a specified value or less, and the transistors 25 to 28 of the main VCM controller 10 stop operation (are turned off) (YES in step S4). If the level of the power supply voltage Vp drops to the specified value or less, the retract circuit (not shown) turns on the transistors 22 and 24 of the VCM controller 12 in accordance with the control signals (TC1 and TC3) (step S5). Accordingly, the capacitor 20, transistor 22, VCM coil 60, transistor 24, and ground 30 form a circuit. That is, a driving current (retract current) in the direction U flows through the VCM coil 60 by the voltage Vd charged in the capacitor 20. Consequently, retract operation (unloading operation) of moving the actuator 7 from the disk 4 to the ramp member 9 is executed (step S6). When the tab 70 of the actuator 7 is held by the ramp member 9, the head 8 retracts to the ramp member 9.

If the head 8 retracts to the ramp member 9 by retract operation (unloading operation), the latch plate 61 attached to the VCM coil 60 is attracted by the magnetic force of the magnet 62, as shown in FIG. 3. In other words, the VCM coil 60 is latched (step S7). Even when slight vibrations or shocks act, the actuator 7 is not driven toward the disk 4 (is latched or locked). Thus, the head 8 remains at the retract position of the ramp member 9. Note that movement of the actuator 7 in a direction opposite to the direction of the disk 4 is limited by a stopper (not shown).

Actuator control operation at the start of loading operation according to the embodiment will be explained with reference to the flow chart of FIG. 4.

Assume that, upon turning on the main power supply of the drive, the CPU 2 starts control of loading operation of moving the head 8 onto the disk 4 (YES in step S1). The CPU 2 turns on the transistor 23 of the VCM controller 12 in accordance with a control signal TC2, and turns on the transistor 28 of the main VCM controller 10 in accordance with a control signal TC7 (step S2).

As a result, the capacitor 20, transistor 23, VCM coil 60, transistor 28, and ground 30 form a circuit. That is, a driving current in the direction L flows through the VCM coil 60 by the boosted voltage Vd charged in the capacitor 20. The boosted voltage Vd is higher in level than the main power supply voltage Vp used in normal control. The VCM 6, therefore, generates a larger driving force than in normal control. The VCM coil 60 moves in a direction in which the latch plate 61 is released from the magnetic force of the magnet 62 (direction opposite to the loading direction of the head 8). At this time, when the driving force of the VCM 6 exceeds a latch force obtained by the magnetic force of the magnet 62, the latched state of the VCM coil 60 (i.e., actuator 7) is canceled (step S3).

After latch release operation is executed, the CPU 2 turns off the transistor 23 of the VCM controller 12, and shifts to normal control. More specifically, the CPU 2 turns on the transistors 25 and 28 of the main VCM controller 10 using the main power supply voltage Vp, and continues loading operation of moving the actuator 7 to the disk 4. In this case, the CPU 2 generally controls the speed of the VCM 6 (moving speed of the actuator 7) on the basis of the counter-electromotive voltage of the VCM 6 until the head 8 is loaded onto the disk 4.

Initially in loading operation (at the start of loading), a driving current larger than in normal control is supplied to the VCM coil 60 latched by the latch mechanism, thereby releasing the latch. In other words, in latch release, an auxiliary power supply formed from the capacitor 20 of the VCM controller 12 can be used to supply a large driving current to the VCM coil 60 at the boosted voltage Vd higher in level than the main power supply voltage Vp. At the start of loading operation, a driving force larger than in normal control can be generated, so that the actuator 7 can release latch (lock) of the latch mechanism and can be rotated toward the disk 4. After the actuator 7 is rotated to move the head 8 from the retract position of the ramp member 9, the CPU 2 can shift to loading operation onto the disk 4 that is included in normal control.

Since a small-size disk drive is used in a small-size portable digital device, as described above, power consumption must be reduced in accordance with the specifications of a low-level power supply voltage (Vp). To avoid a malfunction by vibrations or shocks to the drive, a latch mechanism of latching (locking) the actuator 7 by a strong latch force is required. According to the present invention, the VCM 6 is driven by supplying a high-level voltage (Vd) at the start of loading operation, and latch of the latch mechanism can be easily released.

In short, the actuator control system of the present invention can reduce power consumption in accordance with the specifications of a low-level power supply voltage Vp, and can supply a power corresponding to the specifications of a high-level power supply voltage necessary for releasing latch of the latch mechanism. Since a latch mechanism having a strong latch force can be mounted, a disk drive having a structure resistant to vibrations or shocks can be implemented.

(Modification)

As a modification of the embodiment, the transistor 29 which is turned on in accordance with a control signal TC8 in latch release may be added, as shown in FIG. 2. With this arrangement, the capacitor 20, transistor 23, VCM coil 60, transistor 29, and ground 30 form a circuit without turning on the transistor 28 of the main VCM controller 10 in latch release. That is, a driving current in the direction L flows through the VCM coil 60 by the high-level boosted voltage Vd charged in the capacitor 20. At this time, no current flows through the current detection resistor 13, and an effective latch release current flows through the VCM coil 60.

This embodiment utilizes (i.e., shares) an auxiliary power supply formed from the capacitor 20 of the VCM controller 12 used in retract operation (unloading operation) in latch release operation. However, the present invention is not limited to this, and may adopt an arrangement using an auxiliary power supply made up of a capacitor and diode dedicated to latch release.

Alternatively, the present invention may adopt an arrangement of directly applying the boosted voltage Vd from the DC/DC converter 11 to the transistor 23 necessary for latch release operation without using the capacitor 20 or the like.

This embodiment assumes a magnetic latch type latch mechanism, but the present invention is not limited to this and may employ another type latch mechanism.

As has been described in detail above, according to the present invention, when a latch mechanism for an actuator mechanism which can obtain a latch force enough to resist external vibrations or shocks is used, a VCM driving force enough to release latch in loading operation can be obtained without using any power supply necessary for normal operation. The present invention can, therefore, provide a disk storage device having a mechanism which is reduced in power consumption by decreasing the level of the power supply voltage and is resistant to vibrations or shocks. An application of the present invention can provide a disk drive useful as a data storage device particularly for a small-size portable digital device (mobile information device or the like).

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A disk drive having a head and a disk, comprising:
an actuator mechanism which supports the head, and executes loading operation of moving the head onto the disk by a voice coil motor and unloading operation of moving the head from the disk to a retract position;
latch means for latching said actuator mechanism at a predetermined position when the head is moved to the retract position by the unloading operation;
first control means for controlling a driving current supplied to the voice coil motor, and executing normal control of said actuator mechanism in order to execute movement and positional control of the head on the disk; and
second control means for controlling the driving current supplied to the voice coil motor so as to release latch of said actuator mechanism by said latch means at start of the loading operation of moving the head from the retract position onto the disk.

2. A drive according to claim 1, wherein said latch means latches a driving unit of the voice coil motor by a magnetic force of a magnet included in the voice coil motor.

3. A drive according to claim 1, wherein said second control means comprises power supply means for generating a voltage of a level exceeding that of a power supply voltage used by said first control means, and controls to supply the driving current from the power supply means to the voice coil motor so as to supply a driving force larger than in the normal control to said actuator mechanism.

4. A drive according to claim 3, wherein the power supply means of said second control means includes a capacitor charged by the power supply voltage used by said first control means, and the voltage exceeding the level of the power supply voltage is generated from the capacitor.

5. A disk according to claim 3, wherein the power supply means of said second control means includes a boosting circuit for generating a boosted voltage exceeding the level of the power supply voltage used by said first control means, and a capacitor charged by the boosted voltage, and the voltage exceeding the level of the power supply voltage is generated from the capacitor.

6. A drive according to claim 3, wherein the power supply means of said second control means includes a DC/DC converter for generating a boosted voltage exceeding the level of the power supply voltage used by said first control means, and a capacitor charged by the boosted voltage, and the voltage exceeding the level of the power supply voltage is generated from the capacitor.

7. A disk drive having a head and a disk, comprising:
an actuator mechanism which supports the head, and executes loading operation of moving the head onto the disk by a voice coil motor and unloading operation of moving the head from the disk to a retract position;
first control means for supplying a driving current generated by a main power supply to the voice coil motor, and executing normal control of said actuator mechanism in order to execute movement and positional control of the head on the disk;
retracting means for driving and controlling the voice coil motor using an auxiliary power supply including boosting means for generating a voltage exceeding a voltage of the main power supply and a capacitor charged by the voltage from the boosting means, and executing the unloading operation of the head to the retract position in turning off the main power supply;
latch means for latching said actuator mechanism at a predetermined position when the head is moved to the retract position by the unloading operation; and
second control means for controlling supply of the driving current from the auxiliary power supply to the voice coil motor so as to release latch of said actuator mechanism by said latch means at start of the loading operation of moving the head from the retract position onto the disk.

8. A drive according to claim 7, wherein said latch means latches a driving unit of the voice coil motor by a magnetic force of a magnet included in the voice coil motor.

9. A drive according to claim 7, wherein the auxiliary power supply has a DC/DC converter for generating a boosted voltage exceeding the voltage of the main power supply, and a capacitor charged by the boosted voltage.

10. A method of controlling a head actuator for a disk drive having a head, a disk, an actuator mechanism, and latch means,
the actuator mechanism supporting the head, and executing loading operation of moving the head onto the disk by a voice coil motor and unloading operation of moving the head from the disk to a retract position, and
the latch means latching the actuator mechanism at a predetermined position when the head is moved to the retract position by the unloading operation,
the method comprising the steps of:
supplying a driving current to the voice coil motor at a voltage of a main power supply in normal control of executing movement and positional control of the head on the disk; and
supplying the driving current to the voice coil motor at a voltage higher in level than a power supply voltage of the main power supply at start of the loading operation, and driving the actuator mechanism so as to release the latch with a driving force larger than in the normal control.

11. A method according to claim 10, wherein
the disk drive has an auxiliary power supply for generating a boosted voltage obtained by boosting the power supply voltage of the main power supply, and
the driving step comprises supplying the driving current from the auxiliary power supply to the voice coil motor at the start of the loading operation.

12. A method according to claim 11, further comprising the steps of:
driving and controlling the voice coil motor using the auxiliary power supply, and executing the unloading operation of the head to the retract position in turning off the main power supply.
